(19) United States
(12) Patent Application Publication
(10) Pub. No.: US 2009/0131838 A1
(43) Pub. Date: May 21, 2009

(54) Method and system for the enhancement and monitoring of the healing process of bones

(76) Inventors: Dimitrios Fotiadis, Ioannina (GR); Vasilios Protopappas, Ioannina (GR); Konstantinos Malizos, Larisa (GR); Nikolaos Malizos, Larisa (GR); Iraklis Kourtis, Larisa (GR); Lampros Kourtis, Larisa (GR)

Correspondence Address: Bruce L Adams;Adams & Wilks, 17 Battery Place, Suite 1231, New york, NY, 10004, US

(21) Appl. No.: 11/988,585

(22) PCT Filed: Aug. 2, 2006
(86) PCT No.: PCT/GR2006/000037

§ 371 Date: Jan. 10, 2008

(30) Foreign Application Priority Data
Aug. 24, 2005 (GR) 20050100444

(51) Int. Cl. A61H 1/00

(52) U.S. Cl. 601/2

(57) ABSTRACT

The present invention relates to a method and a system to therapeutically treat bone fractures, nonunions, deformities and also to monitor their healing process using ultrasound waves.

The invention concerns one or more ultrasound transducers that are implanted in contact with the bone adjacent to the affected region, as well as an electronic unit that is either surgically implanted or located extracorporeally and operating altogether as a system, it enhances the healing process of bones and monitors the course of healing. The electronic unit a) generates appropriate signal that excite the transducers (that are in transmitter mode of operation) so that they emit ultrasound waves that are suitable for treating the bones, b) generates appropriate signal that excite the transducers (that are in transmitter mode of operation) so that they emit ultrasound waves, and subsequently acquires the signals that are generated by the transducers (that are in receiver mode of operation) during the reception of the propagating ultrasound waves, and c) is also capable of transmitting the acquired signals to a local or remote computing unit in order to store and analyze the signals so that the physician can evaluate bone healing.

### CROSS-REFERENCE TO RELATED APPLICATION

This application is a U.S. national stage application of International Application No. PCT/GR2006/000037, filed Aug. 2, 2006, claiming a priority date of Aug. 24, 2005, and published in a non-English language.

The present invention belongs to the biomedical field and relates to a method and system for the treatment and evaluation of bone fractures, nonunions and bone deformities using ultrasound. The invention concerns one or more ultrasound transducers that are implanted in contact with the bone adjacent to the affected region, as well as an electronic unit that is either surgically implanted or located extracorporeally and operating in tandem as a system, it enhances the healing process of bones and monitors the course of their healing process.

Bone healing is a complex regenerative process that gradually restores the functional and mechanical properties of the bone, such as the load-bearing capacity, stiffness and strength. Traditionally in clinical practice, assessment of bone healing is performed by clinical and/or radiographic examination. Clinical examination of the affected bone is a subjective evaluation method that strongly depends on the orthopaedic surgeon's experience, whereas the interpretation of the radiographic findings is largely a matter of the clinician's expert judgment.

It is estimated that about one out of ten bone fractures requires further conservative or surgical intervention due to impaired healing, such as delayed union or pseudarthrosis (nonunion). Both healing complications are responsible for substantial morbidity and interference with personal and vocational productivity. Enhancing as well as quantitatively monitoring the healing process is associated with major clinical, social and economical effects.

An intense effort has been devoted to develop means for the enhancement and acceleration of bone healing using physical and biological methods. Physical methods include mechanical stimulation, the application of electromagnetic fields or the application of ultrasound. Basic science, animal studies and clinical trials have demonstrated the potential of ultrasound to enhance and accelerate the healing of bone fractures, delayed unions, and established nonunions. The positive effect of ultrasound on the healing process results in the minimization of the healing time as well as in the increase of the mechanical capabilities of the bone during the healing period.

As observed from animal studies, exposure to ultrasound increases the formation of soft callus (i.e. the connective tissue that is formed at the bone fracture fragments) and results to earlier onset of endochondral ossification, suggesting that the most prominent effect is on the chondrocyte population. Ultrasound has direct effects on cell physiology by increasing the incorporation of calcium ions in in vitro cultures of chondrocytes and bone cells, and stimulating the expression of numerous genes involved in the healing process. In addition to modulating gene expression, ultrasound may increase early blood flow thus enhancing angiogenesis. Moreover, ultrasound, or alternatively “acoustic”, waves transferred at the fracture site, facilitate the directed flow of a nutrient-rich fluid while simultaneously aids towards waste removal (acoustic streaming phenomenon). This phenomenon results in mechanical stimulation of the proliferation and differentiation of the fibroblasts, chondroblasts and osteoblasts. Besides that, the acoustic pressure waves produce microstress fields resulting in a bone mechanical response analogous to the phenomena described by Wolf's law (Wolff J., 1986. The law of bone remodeling, Berlin, Springer-Verlag).

In the aforementioned clinical studies, ultrasound is applied percutaneously (i.e. external to the skin) with the use of a probe focusing at the healing site. U.S. Pat. No. 4,530,360 (Duarte) discloses an apparatus and a method for the treatment of fractured bones, using a transducer in contact with the skin above the fracture that requires immobilization of the patient during treatment. Similarly, in patents U.S. Pat. No. 5,003,965 (Talish) and EP1350540 (Talish) ultrasound is applied percutaneously. Additionally, in patent EP1350540 (Talish), a patient-comfort portable self-contained signal generator is disclosed. The disadvantage of these methods is that the surrounding soft tissue envelope of bones, results in high attenuation of the propagating ultrasonic waves due to absorption, which is proportional to the thickness of this envelope, as well as to beam scattering phenomena. Furthermore, the propagating ultrasound wave is highly reflected at the tissue/bone interface. In this sense, such configurations do not facilitate the efficient transfer of ultrasonic energy directly to the healing region but rather scatter it to the surrounding tissues.

As far as monitoring of the bone healing process is concerned, several methods, such as single photon absorptiometry (SPA), dual-energy X-Ray absorptiometry (DEXA) and quantitative computed tomography (QCT) have been used experimentally to measure the bone mineral density (BMD) of the regenerative tissue (i.e. callus) and relate it with the stiffness and strength of the healing bone. The disadvantage of these methods is that radiographic signs of healing only appear several weeks after actual healing and such methods may not provide reliable information. Many researchers focus their work on the direct measurement of the mechanical properties of the healing bone. Various techniques have been developed to determine the axial and/or bending stiffness of bones by attaching strain gauges to external fixation devices or to custom-made frames. In other techniques, the vibrational behavior of the healing bone is studied using percutaneous accelerometers or using acoustic emission techniques. The above techniques have demonstrated their potential to provide useful indications of the structural and mechanical integrity of the bone during the healing period. Moreover, they have the disadvantage of being influenced by extrinsic properties, such as bone gross geometry, fracture type, etc. In addition they cannot measure the properties of the regenerative connective tissue itself. Besides this, the majority of the above mentioned techniques may only take place in clinical settings requiring the intervention of a specialist to configure the measuring set-up, while in a number of them the temporary removal of the external fixation device is necessary.

In addition to the fracture-enhancement capabilities of ultrasound, ultrasonic methods have been employed as a diagnostic tool in osteoporosis. The majority of the research groups employs a set of two or more transmitters and receivers that are placed percutaneously over the bone region under investigation. The ultrasound propagation velocity and attenuation are used as indicators of the bone's health status. In the assessment of osteoporosis, the ultrasound velocity of osteoporotic and healthy bones has been shown to correlate with the bone mineral density and strength. In patent EP0747011 (Barry), an ultrasonic bone analysis apparatus is disclosed for the evaluation of the calcaneous and phalanges. Patent WO9945348 (Kantorovich) discloses a method for determining the bone ultrasound velocity using a measuring probe that is placed percutaneously and has a high spatial resolution. In patent U.S. Pat. No. 6,468,215 (Sarvazyan and Tatarinov), a method involving unilateral sequential measurements over the surface of the soft tissue surrounding the bone is disclosed to assess the bone condition.

The disadvantages of the three aforementioned methods and particularly of percutaneous measurements are that the overlying soft tissues significantly affect the repeatability and accuracy of the measurements, as the propagation wavepath is not known, and the method is only applicable to peripheral skeletal sites, such as the radius, the calcaneus and the phalanges where the surrounding tissues are thin. Another disadvantage is that they require the patient's visit to a clinical setting and the intervention of a specialist to configure the measuring framework, thus rendering frequent measurements unattainable and increasing the overall cost of the examination. In addition, the repeatability of the measurements is limited since the placement of the transducers is subjected to a manual procedure.

The present invention is the first to disclose the transosseous (i.e. through the bone) application of ultrasound using transducers placed in direct contact with the bone for both the treatment and evaluation of bone fractures, delayed unions, nonunions or bone deformities, such as limb-lengthening cases (distraction osteogenesis).

Referring to the therapeutic application, the transosseous propagation of ultrasound facilitates the efficient delivery of ultrasonic energy directly to the healing area. The transosseously propagating ultrasonic waves are not subjected to reflection and scattering phenomena from the surrounding soft tissues, as is the case in the aforementioned state of the art methods and devices, but are rather confined within the bone and guided along its dimensions (wave-guidance phenomenon). On the contrary, in percutaneous applications, ultrasound is subjected to wave absorption and beam scattering as it propagates through the soft tissues and is also highly reflected at the soft tissue/bone interface. Therefore, unlike percutaneous applications, the use of transosseous ultrasound may require lower levels of wave intensity, while preserving the optimal efficacy for the treatment.

Another advantage of the present invention is that the ultrasonic therapy can be applied to various skeletal sites in which the surrounding soft tissue is not necessarily thin, such as femoral fractures. The application is therefore not restricted to peripheral skeletal sites, as required by the percutaneous application of therapeutic ultrasound.

Another advantage of the present invention is that the performance of a treatment session does not require the manual attachment of the transducers by the patient or a physician.

Referring to the healing process monitoring capability, the present invention is the only that achieves quantitative evaluation of bone healing process. More specifically, the transosseous propagation supports the acquisition of measurements directly from the healing tissue, thus overcoming problems associated with the interference of the surrounding soft tissues. In addition, the measurement procedure does not involve the manual placement of the transducers each time a measure is to be performed, ensuring the repeatability and accuracy of the measurements. Animal and clinical studies have demonstrated that various characteristics of the ultrasound propagation through the healing tissue are gradually evolving during the healing period approaching the characteristics of propagation in normal bone. This gradual evolution in the wave characteristics is attributed to changes in the material and mechanical properties of the healing tissue that occur during the healing period. A variety of wave propagation characteristics, such as wave propagation velocity, wave attenuation, frequency response, velocity dispersion of guided wave modes, backscattered wave energy, can be extracted and analyzed from the received signals, in order to determine the properties of the healing bone and quantitatively evaluate the status of healing. In addition, ultrasound measurements can be acquired frequently, or even continuously at the patient's site. Therefore, the course of healing can be monitored throughout the healing period.

The present invention integrates a therapeutic and a monitoring functionality into a single system. The system can be configured to operate in an autonomous fashion, without the intervention of the patient or a health professional. It can also operate in telemetry mode, allowing thus the management of patients in out-hospital conditions and the transmission of the collected signals to the health professionals. In this sense, the patient's follow-up visits are reduced, while at the same time the doctors can remotely monitor multiple patients as well as intervene and customize their therapy in an individual fashion based on the patient's needs.

The present invention relates to a method and a system to therapeutically treat bone fractures, nonunions, deformities and also to monitor their healing process using ultrasound waves. Ultrasound waves are transmitted subcutaneously (i.e. internal to the skin) and propagates transosseously (i.e. through the bone) via a set of transducers that are implanted adjacent to the healing area and attached to the bone. The ultrasound transducers are controlled by an electronic unit that is either surgically implanted or located extracorporeally and operating in tandem as a system, they enhance the healing process of bones and monitor the course of their healing process. More specifically, the electronic unit a) for the enhancement of the healing process, generates appropriate signal that excite the transducers (that are in transmitter mode of operation) so that they emit ultrasound waves, b) for the monitoring of the healing process, generates appropriate signal that excite the transducers (that are in transmitter mode of operation) so that they emit ultrasound waves, and subsequently acquires the signals that are generated by the transducers (that are in receiver mode of operation) during the reception of the propagating ultrasound waves, and c) is also capable of transmitting the acquired signals to a local or remote computing unit in order to store and analyze the signals so that the physician can evaluate the healing process.

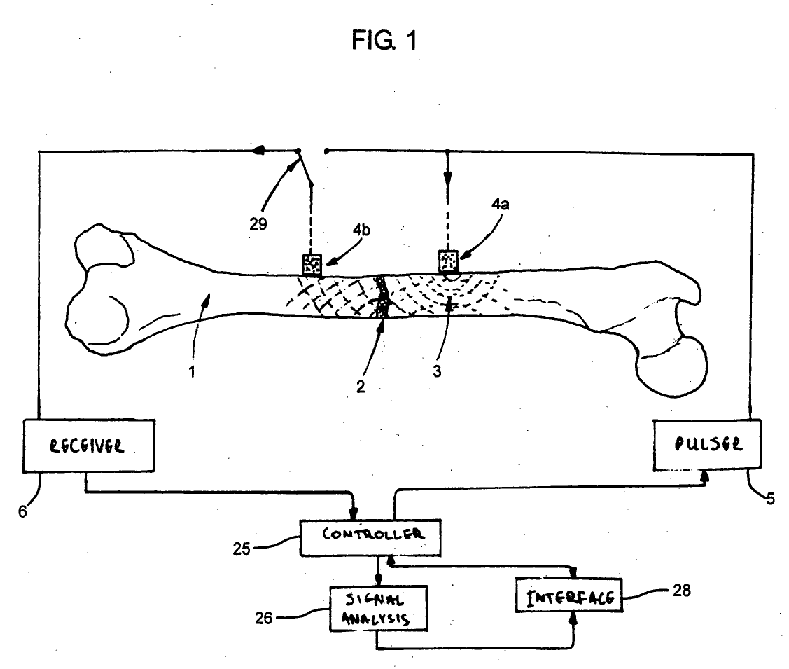

FIG. 1 is a schematic view of the overall invention with the transducers (4a and 4b placed on the surface of the bone (1)) and the main functional components, (pulser (5), receiver driving stage (6), controller (25), signal analysis module (26) and user interface module (28)).

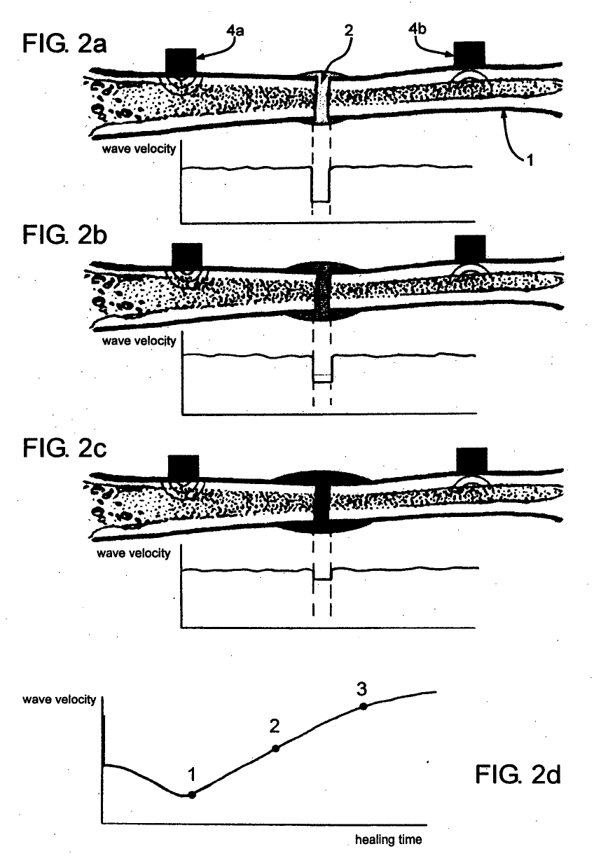

FIGS. 2a, 2b, 2c and 2d demonstrate the principle of the propagation velocity measurement method utilized to evaluate the bone healing status.

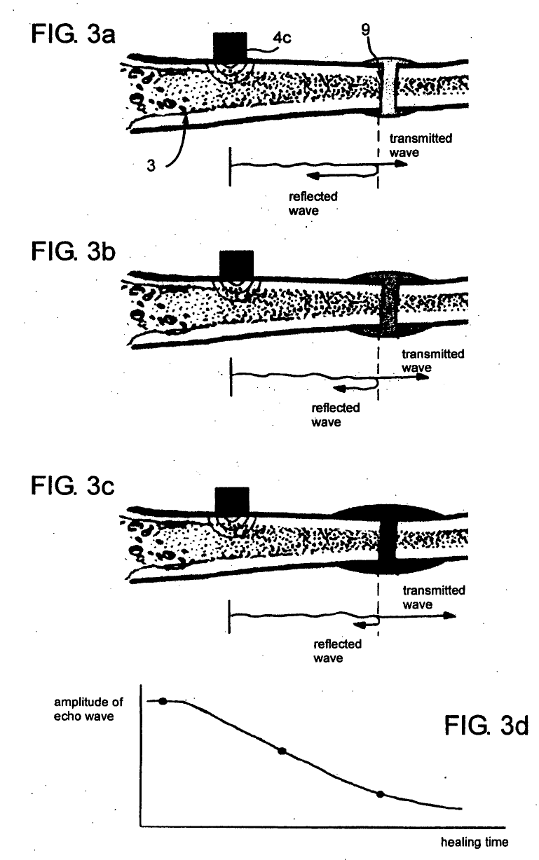

FIGS. 3a, 3b, 3c and 3d demonstrate the principle of the echo measurement method utilized to evaluate the bone healing status.

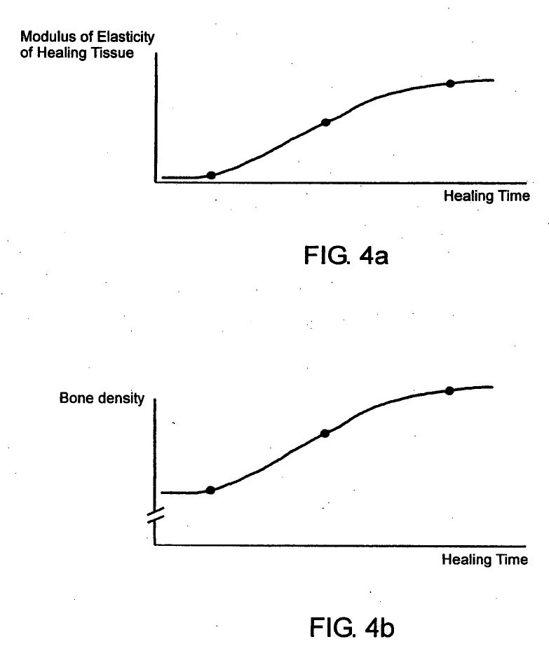

FIG. 4a depicts the evolution of the elastic modulus of the healing tissue against healing time in normal healing. FIG. 4b depicts the evolution of bone apparent density as healing progresses in normal healing.

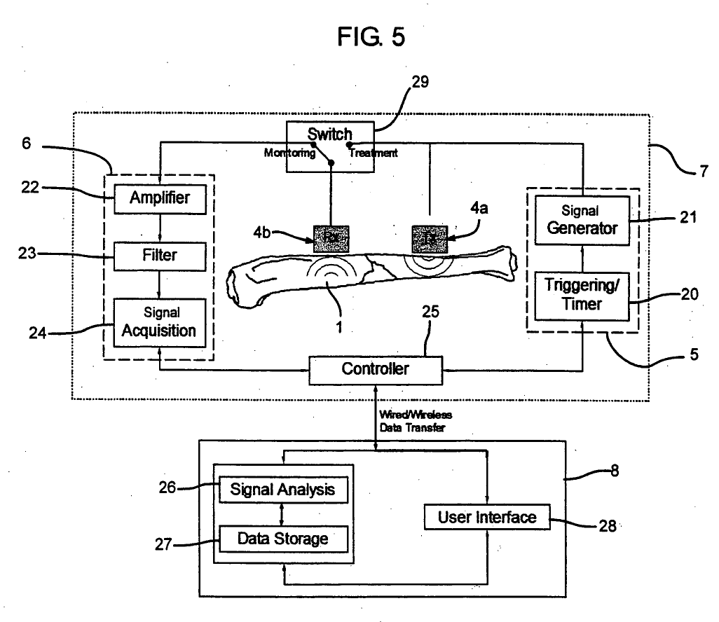

FIG. 5 depicts a block diagram of the system architecture.

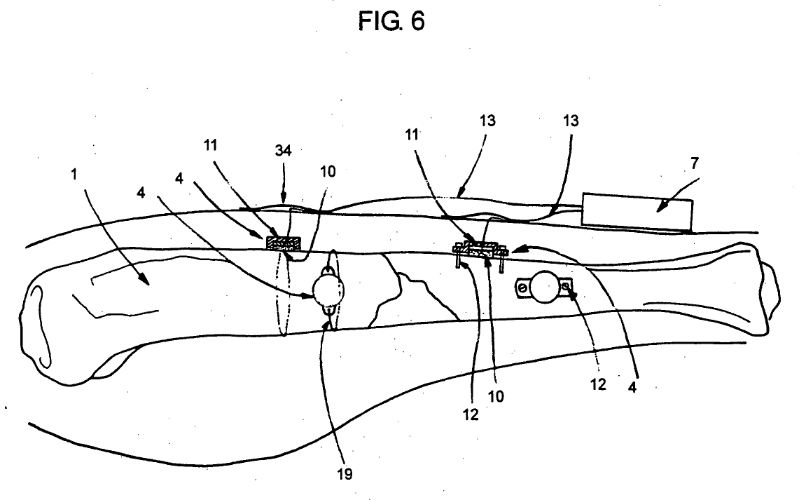

FIG. 6 depicts two embodiments of the present invention in which four transducers (4) are attached to the bone (1) in two different ways. In the first one, the transducers (4) on the lefthand side are attached to the bone (1) via circumferential surgical wires (19). The transducers (4) on the righthand side are mounted on the bone (1) via bone screws (12). The electronic unit (7), placed extracorporeally, is connected to the transducers (4) via cables (13).

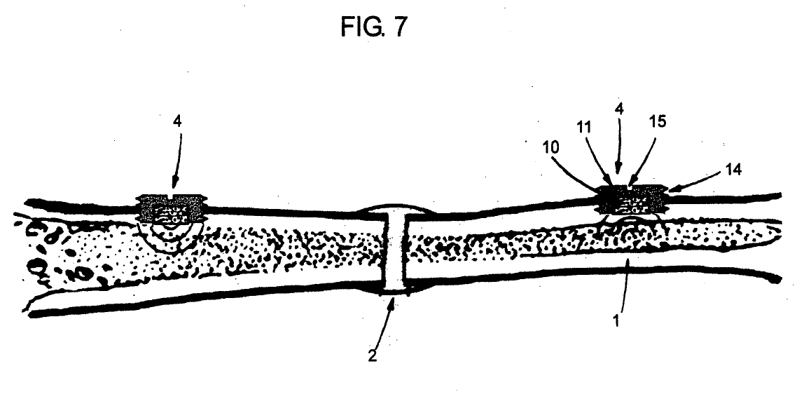

FIG. 7 depicts another embodiment of the present invention in which each transducer (4) is fixed onto or inside the bone (1) by means of threading (14) on the external surface of the housing (11) of the transducer.

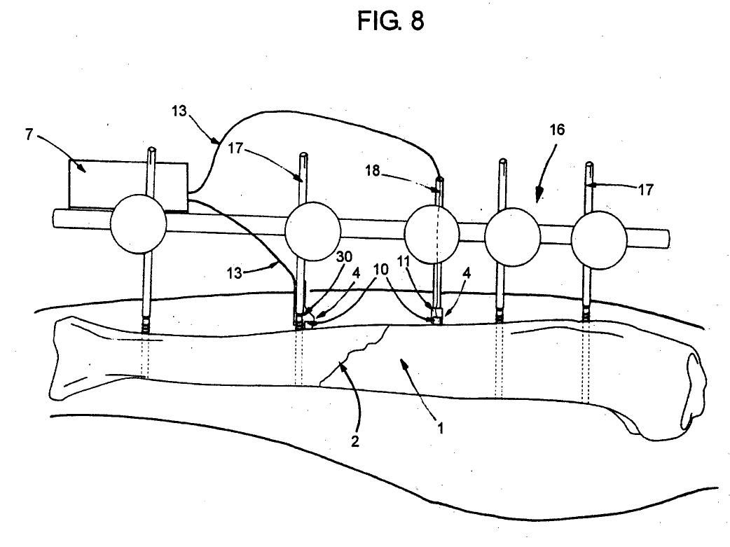

FIG. 8 depicts two embodiments of the present invention for a fracture case treated with the application of an external fixation device (16).

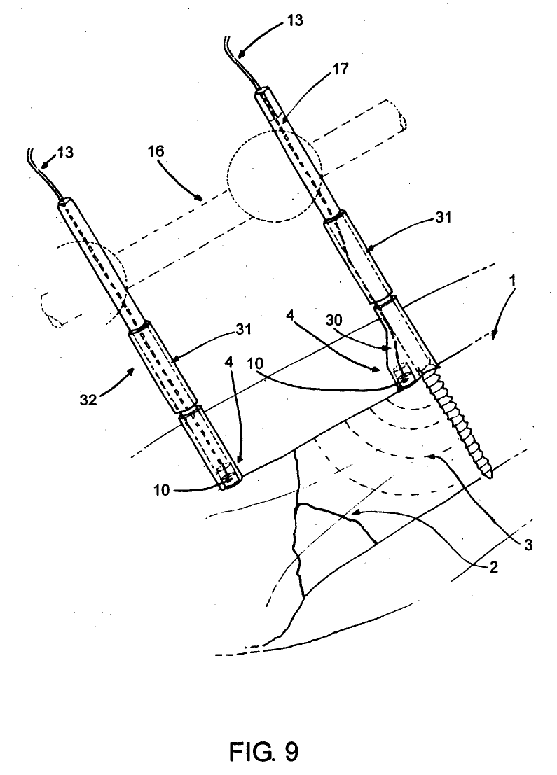

FIG. 9 is a detailed aspect of the embodiment shown in FIG. 8 with the two transducers in inverse position.

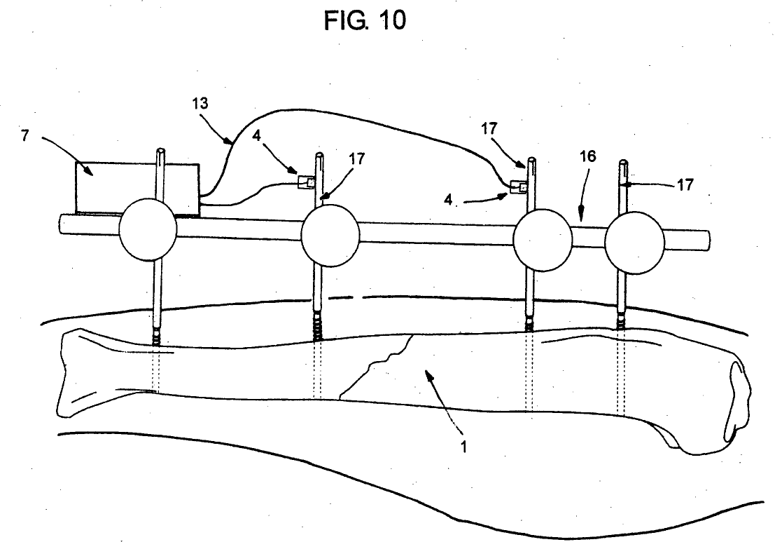

FIG. 10 depicts another embodiment of the present invention for a fracture case treated with the application of an external fixation device (16) where the transducers (4) are placed extracorporeally

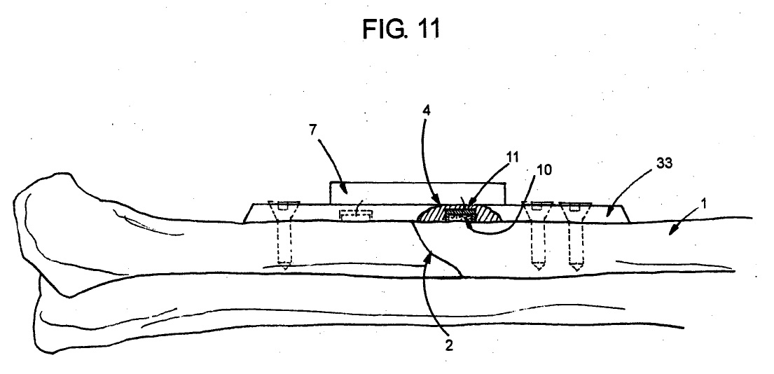

FIG. 11 depicts an embodiment of the present invention where two transducers (4) are placed on the bone (1) making use of an internal fixation device (33).

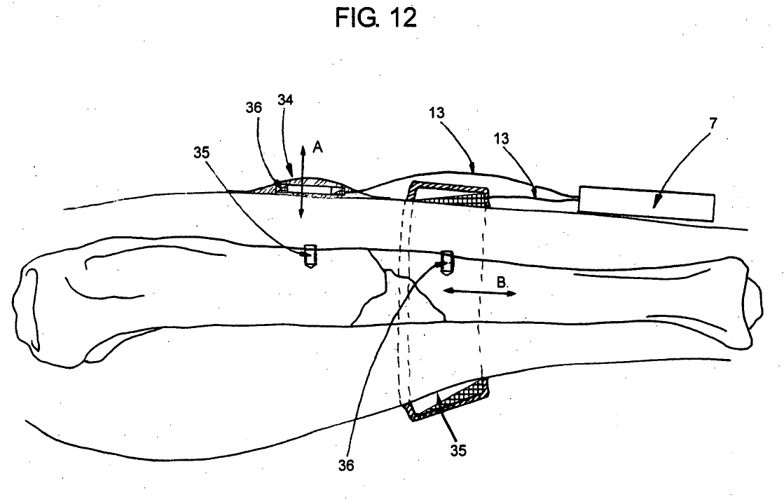

FIG. 12 depicts another embodiment of the present invention utilized to create and receive ultrasound waves for treatment and monitoring of the healing process based on the magnetic induction (Lorenz) effect or the magnetostriction effect.

The ultrasound transducers (4) can operate either as transmitters i.e. transform electric signals to mechanical waves (hereby referred to as 4a), or as receivers i.e. transform mechanical waves to electric signals (hereby referred to as 4b). Transducers (4) can also operate as transceivers i.e. first serve as transmitters and then as receivers (hereby referred to as 4c).

Physical contact, rigid attachment and acoustical coupling between the implanted transducers (4) and the bone (1) are ensured via mechanical means. The transducers (4) are either attached directly to the bone (1), or they are supported against the bone (1) by an orthopaedic fixation (internal or external) device (16 or 33 respectively).

As shown in FIGS. 1 and 5, for treating the healing bone, a number of implanted transducers (4a) (operating in the transmitter mode) are driven by an electronic unit (7) so as to generate ultrasound waves (3) of appropriate parameters, such as intensity, frequency, rate of pulse repetition, time period of application, etc., said ultrasound waves (3) propagate transosseously (i.e. through the bone) and reach the healing area. The electronic unit (7) can be either implanted or located extracorporeally. The electronic unit (7) may incorporate a user interface (28) for providing input/output to the doctor and the patient and also store therapy parameters, as shown in FIGS. 1 and 5.

For monitoring the progress of the healing bone, the system operates in a transmitter-receiver configuration as shown in FIGS. 1, 2 and 3. The electronic unit (7) drives a transducer (4a) (operating in the transmitter mode) that is located on one side of the healing area to generate ultrasound waves (3) which propagate through the bone (1) and the healing area (2). The propagating waves (3) are received by one or more transducers (4b) (operating in the receiver mode) located on the opposite side of the healing area (2), as shown in FIG. 2. The produced signals are acquired by the electronic unit (7) for storage and analysis purposes. Alternatively, the electronic unit (7) drives a transducer (4c) (operating in the transceiver mode) to generate ultrasound waves (3) which propagate through the bone (1) and are reflected from the discontinuity (9) induced by the bone—healing area interface. The backscattered waves (echo waves) are received by the said transducer (4c), as depicted in FIG. 3. The produced signals are acquired by the electronic unit (7) for analysis and storage purposes.

As shown in FIG. 5, the electronic unit (7) incorporates a pulser module (5) that creates the driving signals, a receiver driving stage (6) that acquires, amplifies and filters the received signals, and a controller (25) to supervise the operation of the electronic unit (7). The electronic unit (7) may incorporate a user interface (28) for providing input/output to the doctor and the patient and may also communicate the acquired signals to a local or remote computing unit (8). The computing unit (8) stores and analyzes the signals in order to determine the properties of the healing bone and provide the doctor with quantitative information that can be used for clinical evaluation.

Bone healing is a dynamic process. During early healing phases, the callus (i.e. the regenerative tissue formed at the fracture site) exhibits mechanical and acoustical properties that are different than those at later phases. FIG. 4 illustrates the evolution of callus apparent density (ρ) and modulus of elasticity (E) as healing progresses with time. FIG. 4a depicts the evolution of the elastic modulus of the healing tissue against healing time in normal healing. FIG. 4b depicts the evolution of bone apparent density as healing progresses in normal healing. Similar behavior is demonstrated also for other callus properties, such as stiffness, strength, bulk velocity, acoustic impedance, etc.

Ultrasound signals can be obtained and analyzed at various phases of the healing process. Various wave propagation characteristics can be extracted and analyzed from the acquired signals. The wave characteristics may include the velocity of ultrasound wave propagation, the attenuation of ultrasound waves, the frequency response, the dispersion of velocity of guided wave modes, as well as other characteristics lying in both the time and frequency domain. The variation of each wave characteristic over the healing period can reflect the material, mechanical, structural and metabolic changes that take place throughout the healing period, as depicted in FIGS. 2d and 3d.

One significant wave propagation characteristic, measured in transmitter-receiver mode of operation, is the velocity (c_{L} and c_{T}) of ultrasound propagation through the bone and the healing tissue, determined by the transit time of the propagating bulk wave and the transducers' in-between distance. The propagation velocity is related to both the modulus of elasticity (E) and the density (ρ) of the medium, according to the formulae:

$$\begin{matrix}{c}_{L} = \sqrt{\frac{E ( 1 - v )}{ρ ( 1 + v ) ( 1 - 2 v )}} , for longitudinal ( compression ) wave & ( 1 ) \\ {c}_{T} = \sqrt{\frac{E}{2 ( 1 + v ) ρ}} , for shear wave & ( 2 )\end{matrix}$$

where ν is the Poisson's ratio.

FIGS. 2a, 2b, 2c and 2d demonstrate the principle of the propagation velocity measurement method utilized to evaluate the bone healing status. Three consecutive phases of the bone healing process are hereby presented in which the formation and consolidation of callus at the fracture site is represented. FIGS. 2a, 2b and 2c correspond to an early, a medium and a late phase of the healing process, respectively. The transducers (4a and 4b) are placed directly on the bone (1) (Tx stands for the transmitter mode of operation and Rx stands for the receiver mode of operation). Below each bone sketch, graphs representing a topological variation of the bulk velocity along the bone's long axis, are provided. The ordinate of each graph indicates bulk velocity, whereas the abscissa is the spatial variable taken along the bone's axis. FIG. 2d is a typical graph curve showing the measured propagation velocity (integrated over the propagation length from transmitter to receiver) versus the healing period (usually taken in days or weeks). Points a, b and c in FIG. 2d correspond to the healing process phases pictured in FIGS. 2a, 2b, and 2c, respectively.

As healing progresses, the propagation velocity gradually approaches the velocity through the intact bone Therefore, the evolution of the propagation velocity throughout the healing period constitutes a significant indicator of the progress of healing.

Another significant wave characteristic, measured in transceiver mode of operation, is the ultrasonic energy that is reflected from the fracture discontinuity (9). The reflected energy depends on the difference between the acoustic impedances of the intact bone (Z₁) and the healing tissue (Z₂). The ratio of the reflected to the incident energy is described by the coefficient of reflection (R) given by the formula:

$$\begin{matrix}R = {( \frac{{Z}_{2} - {Z}_{1}}{{Z}_{2} + {Z}_{1}} )}^{2} , \\ where & ( 3 ) \\ {Z}_{i} = {ρ}_{i} {c}_{Li} , & ( 4 )\end{matrix}$$

where the index i=1, 2 denotes bone and healing tissue, respectively.

FIGS. 3a, 3b, 3c and 3d demonstrate the principle of the echo measurement method to utilized to evaluate the bone healing status. Three consecutive phases of the bone healing process are presented in which callus formation and consolidation occurs at the fracture site. FIGS. 3a, 3b, 3c correspond to an early, a medium and a late phase of the healing process, respectively. The transducer (4c) is placed directly on the bone (1) (TRx stands for transceiver mode of operation). Below each bone sketch, graphs represent the ultrasonic energy that is reflected at the fracture site and the portion of energy that is transmitted through the fracture site due to impedance mismatch caused by the material discontinuity (9) between bone and healing area. FIG. 3d is a typical graph showing the variation of the received reflected (i.e. backscattered) energy against the healing period (usually taken in days or weeks). Points a, b and c in FIG. 3d correspond to the healing phases pictured in FIGS. 3a, 3b, and 3c, respectively.

The amount of the reflected (i.e. backscattered) and transmitted energy from the healing area at various healing phases is depicted in FIGS. 3a, 3b, 3c and the variation of the reflected energy through the healing period is depicted in FIG. 3d. As healing progresses, the acoustic impedance of the healing tissue gradually matches that of bone and as a result the backscattered energy decreases, while the transmitted energy increases. Therefore, the evolution of the backscattered energy throughout the healing period constitutes a significant wave propagation characteristic in the monitoring of the healing progress.

Another significant wave characteristic, measured in the transmitter-receiver mode of operation, is the attenuation of the propagating waves. Wave attenuation can be determined either from the amplitude of the signal (time analysis) and/or from the frequency content of the signal (spectral analysis). Attenuation of the propagating waves generally decreases as healing progresses.

Other significant wave characteristic can be derived from the propagation characteristics of the modes of guided waves that are formed within the bone. These guided modes propagate along the bone in the form of wave packets at different velocities. The dispersion of the velocity of each guided wave mode is affected by the material and geometry properties of the healing bone as a function of frequency and, therefore, constitutes a significant wave characteristic for the evaluation of the healing process.

The ultrasound propagation velocity and the backscattered energy represent characteristics that can be extracted from analysis in the time domain, the wave attenuation can be calculated in the time or in the spectral domain of the signal, whereas velocity dispersion of the guided modes constitutes a characteristic in the time-frequency domain.

Therefore, the above wave propagation characteristics can be used in order to determine the properties of the healing bone. Additionally, the pattern of evolution of the wave characteristics over the healing period can provide a means of monitoring the process of healing, early detecting healing complications (e.g. delayed unions, nonunions), and accurately determining the endpoint of healing.

The present invention relates to a method and a system to therapeutically treat bone fractures, nonunions and deformities as well as to monitor the healing process using ultrasound waves.

Non restrictive embodiments of the current invention are hereby described with relation to the figures.

FIG. 1 is a schematic view of the overall invention with the transducers (4a and 4b) (operating in transmitter mode on the righthand side of the fracture and operating in receiver mode on the lefthand side of the fracture) placed on the surface of the bone (1). The main functional components, i.e. the pulser (5), the receiver driving stage (6), the controller (25), the signal analysis module (26) and the user interface module (28), are also presented in the block diagram.

As shown in FIG. 1, the ultrasound waves (3) are generated and received by a set of transducers (operating in transmitter mode (4a) or in receiver mode (4b), respectively) that are implanted in contact with the bone (1), adjacent to the healing area (2). For the treatment procedure, the transducers (4a) operate in the transmitter mode to transosseously deliver therapeutic ultrasonic energy to the healing area (2) that is the healing bone connective tissue. Concerning the monitoring procedure, the system makes use of a transmitter-receiver transducer (4a and 4b) configuration in which the transmitter (4a) generates ultrasound waves (3) that propagate transosseously and consequently are received by the receiver (4b). Alternatively, a transducer (4c) may operate in the transceiver mode, being both a transmitter of ultrasound waves and in turn a receiver of the reflected ultrasound waves. The acquired signals are stored and further analyzed to provide an evaluation of the bone healing status and assist the physician to clinically assess the healing process.

In both the above described modes, the transducers (4) are driven by an electronic unit (7) as shown in FIG. 5. The electronic unit (7) can be implanted or located extracorporeally as a portable or desktop apparatus. FIG. 5 depicts a block diagram of the system architecture. The blocks within the dotted box represent the modules of the electronic unit (7). The electronic unit (7) includes the pulser module (5) and the receiver driving stage (6). In more detail, FIG. 5 presents the components of the electronic unit (7) that is the controller (25), the components that make up the pulser (5), namely the triggering/timer module (20) and the signal generator (21), the components that make up the receiver driving stage (6), namely the signal acquisition module (24), the filter (23) and the amplifier (22), and the switch (29). FIG. 5 also presents the components that make up the computing unit (8), namely the signal analysis module (26), the data storage module (27) and user interface/visualization module (28); components that can either be located locally, e.g. inside or near the electronic unit (7), or remotely, e.g. at a physical distance from the patient.

As shown in FIG. 5, a pulser module (5) is responsible to excite the transducer(s) (4) which in turn transmit ultrasound waves of appropriate parameters, such as frequency, intensity, pulse repetition rate and duration. For instance, the wave parameters for the treatment procedure (e.g. transmission of bursts of sine waves at an appropriate pulse repetition rate for an appropriate period of time) may be different than those wave parameters required for the monitoring procedure (e.g. transmission of a short pulse).

As shown in FIG. 5, the receiver driving stage (6) of the electronic unit (7) consists of an amplifier (22), a filter (23) and a signal acquisition module (24) and is responsible for receiving, amplifying, and filtering the signals from the transducers. The triggering/timer module (20) synchronizes the signal generator (21) with the receiver driving stage (6). A switch (29) determines a transducer's mode of operation (i.e. transmitter versus receiver) by connecting or disconnecting it from the pulser module (5) or to the receiver driving stage (6). A controller (25) supervises the operation of the various components of the electronic unit (7), stores programs, has processing capabilities, and also is capable of communicating with a computing unit (8) or/and a user interface module (28). The user interface module (28) provides visualization of the measurements and provides an interface for input/output between the electronic unit (7) and the end users of the system, namely the health professionals and the patients. The role of the computing unit (8) is to perform ultrasound signal analysis, store the collected signals, log files (e.g. measurement parameters), and patient-related information. The computing unit (8) can either be integrated with the electronic unit (7) in a single apparatus or can be located proximally to the electronic unit (7) or even can be located at a remote location in which case, communication with the electronic unit (7) can be established using wired or wireless technologies.

In the embodiments shown in FIGS. 6, 7, 8, 9, 10 and 11 the transducers (4) are piezoelectric elements (10) of appropriate polarization, nominal frequency and performance, encapsulated in an appropriate housing (11), and are appropriately connected to the electronic unit (7) via cables (13). The transducers (4) are attached to the bone (1) via mechanical means.

FIG. 6 depicts two embodiments of the present invention in which four transducers (4) are attached to the bone (1) in two different ways. In the first one, the transducers (4) on the lefthand side are attached to the bone (1) via circumferential surgical wires (19). The wire (19) loops around the circumference of the bone (1) and is attached to the housing (11) of the transducer (4)) in order to rigidly fix the transducer (4) onto the bone (1), as shown in FIG. 6, lefthand side.

The transducers (4) on the righthand side are mounted on the bone (1) via bone screws (12). Bone screws (12) can go through the housing (11) of transducer (4), and/or even through the piezoelectric element (10) itself, in case the piezoelectric element (10) is of annular shape.

Alternatively, the housing (11) of the transducer (4) may hold external threading (14) and appropriate drive socket (15) so that the transducer (4) can be screwed into the bone (1) as shown in FIG. 7.

The electronic unit (7), placed extracorporeally, is appropriately connected to the transducers (4) via cables (13).

In another embodiment of the present invention, the transducer (4) is glued onto the bone (1), using biocompatible orthopaedic glue or cement.

In the abovementioned embodiments of the present invention, the electronic unit (7) can be implanted or can be located extracorporeally, as shown in FIG. 6, in which case the exit skin points of the cables (13) may be covered by epidermal adhesive patches (34) for aesthetic reasons and for protection against infections.

In embodiments of the present invention pictured in FIGS. 8, 9 and 10 the transducers (4) are mounted onto the bone (1) by making use of the application by the orthopaedic surgeons of an external fixation device (16). External fixation devices are commonly employed in order to reduce and fixate bone fractures.

FIG. 8 depicts two embodiments of the present invention for a fracture case treated with the application of an external fixation device (16). In this figure, the transducers (4) are fixed against the bone (1) in two different ways:

The transducer (4) on the righthand side of FIG. 8 is incorporated at the tip of a stylet (18) that is in turn supported by the external fixation device (16) as shown in FIG. 8 concerning the righthand side transducer (4) and in FIG. 9 concerning the lefthand side transducer (4). The stylet-transducer assembly (32) is not intended to be a load-bearing external fixation pin, but is rather a transducer-carrier. The stylet-transducer assembly (32) may be preloaded against the bone to force contact between transducer (4) and bone (1) via tightening means (31); such means can be threading or similar.

The transducer (4) on the lefthand side of FIG. 8 is placed aside to an external fixation pin (17), via a supporting sheath (30). The supporting sheath (30), adjustably attached to the intracorporeal part of the external fixation pin (17), carries the transducer (4) with the piezoelectric element (10), as shown in FIG. 8 with regard to the lefthand side transducer (4), and also in FIG. 9 in a more detailed view with regard to the righthand side transducer (4). For ensuring rigid attachment of the transducer (4) with the bone (1), means of tightening (31) can be employed; such means can be threading or similar.

In these two embodiments, the electronic unit (7) is mounted on the external fixation device (16) frame.

The attachment manner of the transducer (4) to the pin (17) or stylet (18), in both the above mentioned embodiments of the present invention, can be such that the transducer (4) can sustain axial retraction, in order to compensate for possible radial bone growth; this can be achieved by using a spring loaded telescopic stylet. Cables (13) that connect the transducer (4) to the electronic unit (7) may run through a hollow part of the external fixation pin (17) or the stylet (18) and exit at some point extracorporeally.

In another embodiment of the present invention, shown in FIG. 10, the ultrasound waves are transmitted transosseously by making use of an already applied external fixation device (16). The transducers (4) are mounted and acoustically coupled with the external fixation pins extracorporeally (17) in such manner that waves generated by the transducers propagate through the external fixation pin (17) and then are transmitted subcutaneously at the point of contact between the pin (17) and the bone (1) and propagate transosseously. In this sense, the transducer-external fixation pin assembly operates altogether as an ultrasound transducer.

FIG. 11 depicts an embodiment of the present invention where two transducers (4) are placed on the bone (1) making use of an internal fixation device (33) in such a way that there is an effective coupling between the transducer's (4) piezoelectric element (10) and the bone (1). The internal fixation device (33) may hold appropriate openings to host the transducers (4) or hold side supports for hosting the transducers (4). In this embodiment, the electronic unit (7) can be located on the internal fixation device (33) as shown in FIG. 11, or can be located extracorporeally.

In the embodiment of the present invention shown in FIG. 12, electromagnetic acoustic transducers are employed. The implanted magnetic element (35) can be an appropriately oriented magnetic body or a small coil, or a metallic body that is glued or screwed on the bone (1). In the transmitter mode, the implanted element (35) is excited by induction (Lorentz) forces or by the magnetostriction effect by interacting with an electromagnetic field generated by an extracorporeal electromagnetic coil (36) so that ultrasound waves. In the receiver mode, the implanted element (35) receives the propagating ultrasound waves and generates electric signals to the extracorporeal electromagnetic coil (36) by means of electromagnetic induction, said signals are acquired by the electronic unit (7). As shown in FIG. 12, the coil's (36) magnetic field direction can be co-axial to the axis of the bone according to arrow A, or the coil's magnetic field direction can be perpendicular to the axis of the bone, according to arrow B. The coil (36) may be attached to the skin via an adhesive patch (34), or via a strap.

The present invention is applied for the enhancement and evaluation of the healing process of bone fractures, nonunions and bone deformities.

1. Method for the enhancement of the healing process of bone tissue using ultrasound characterized by that ultrasound is transmitted transosseously (i.e. through the bone) and by that it may perform quantitative monitoring of the healing process of bone, and is applied as described hereafter:
a. one or more ultrasound transducer(s) (4) are attached to the bone (1) in the proximity of the healing area (2),
b. one or more transducers (4a) transmit ultrasound waves (3) of certain intensity, frequency and duration in such manner that the waves (3) propagate transosseously (i.e. through the bone) and reach the healing area (2),
c. thereafter, the mode of operation may be in a transmitter-receiver configuration whereby the transmitter-transducer (4a) transmits ultrasound waves (3) in such manner that the waves (3), propagate transosseously and through the healing area (2), and are received by the receiver-transducer (4b) or
the mode of operation may be in a transmitter-receiver configuration whereby the transceiver-transducer (4c) transmits ultrasound waves (3) in such manner that the waves (3) propagate transosseously and receives the backscattered waves that are reflected from the material discontinuity (9) between bone and healing area,
d. the received waves (either from the receiver-transducer, or from the transceiver-transducer) are analyzed to determine the propagation velocity of ultrasound wave, the attenuation of ultrasound wave, the dispersion of velocity of guided wave modes, the backscattered wave energy and other temporal and spectral characteristics of wave propagation; the mechanical, material and geometrical properties of the healing bone tissue are estimated and the course of bone healing is evaluated.

2. System for the enhancement of the healing process of bone tissue using ultrasound according to claim 1, characterized by that ultrasound is transmitted transosseously and by that it may perform quantitative monitoring of the healing process of bone, that consists of:
a. One or more ultrasound transducers (4) that are attached to the bone (1) in the proximity of the healing area (2) assuring acoustic coupling with the bone (1), appropriately connected to an electronic unit (7), and
b. an electronic unit (7) that
b.a. for the enhancement of the healing process, excites the transmitter-transducers (4) to generate ultrasound waves (3) of certain intensity, frequency and duration in such manner that the waves (3) propagate transosseously (i.e. through the bone) and reach the healing area (2),
and that
b.b. for the monitoring of the healing process, excites the transmitting transducer (4a) to generate ultrasound waves (3) that propagate transosseously and through the healing area (2), said electronic unit (7) thereafter acquires the signals generated by the receiver-transducer (4b) during the reception of said propagating waves, or
excites the transceiver-transducer (4c) to generate ultrasound waves (3) that propagate transosseously, said electronic unit (7) thereafter acquires the signals generated by the receiver-transducer (4c) during the reception of the backscattered waves that are reflected from the material discontinuity (9) between bone and healing area,
thereafter, the electronic unit (7) may transmit the acquired signals to a local or remote computing unit (8) that stores and analyzes them, for the determination of the propagation velocity of ultrasound wave, the attenuation of ultrasound wave, the dispersion of velocity of guided wave modes, the backscattered wave energy and of other temporal and spectral characteristics of wave propagation; the mechanical, material and geometrical properties of the healing bone are estimated and the course of bone healing is evaluated.

3. Method and system according to claims 1 and 2 characterized by that the transosseous ultrasound wave used for therapy and monitoring, has central frequency that ranges from 50 KHz to 20 MHz with optimum at 1 MHz, adjusted according to the type of bone, the type of fracture and the site of fracture.

4. Method and system according to claims 1 and 2 characterized by that the transosseous ultrasound wave used for therapy and monitoring, has intensity that ranges from 1 mW/cm2 to 1000 mW/cm2 with optimum at 30 mW/cm2, adjusted according to the type of bone, the type of fracture and the site of fracture.

5. Method and system according to claims 1, 2, 3 and 4 characterized by that the status of the bone healing process is determined by the velocity of the ultrasound wave, as it propagates transosseously and through the healing area (2).

6. Method and system according to claims 1, 2, 3 and 4 characterized by that the status of the bone healing process is determined by the attenuation of the ultrasound wave as it propagates transosseously and through the healing area (2).

7. Method and system according to claims 1, 2, 3 and 4 characterized by that the status of the bone healing process is determined by the dispersion of velocity of the guided wave modes, said guided waves being formed within the bone and propagating transosseously and through the healing area (2).

8. Method and system according to claims 1, 2, 3 and 4 characterized by that the status of the bone healing process is determined by the backscattered wave energy that is reflected from the bone—healing area discontinuity (9).

9. Method and system according to claims 1, 2, 5, 6, 7 and 8 characterized by that the course of the bone healing process is determined by the evolution, during the healing period, of the measured
propagation velocity or/and
attenuation of the ultrasound wave or/and
dispersion of velocity of the guided wave modes or/and
backscattered wave energy.

10. Method and system according to claims 1 and 2 characterized by that each transducer (4) is attached to or into the bone (1) via appropriate mechanical means.

11. Method and system according to claims 1, 2 and 10 characterized by that each transducer (4) is adjustably attached against the bone (1) via a stylet (18) that carries the transducer (4) at its intracorporeal tip; said stylet (18) is in turn adjustably supported by an external fixation device (16).

12. Method and system according to claims 1, 2 and 10 characterized by that each transducer (4) can be attached against the bone (1) via a sheath (30) that is adjustably attached to an external fixation pin (17) that is in turn supported by an external fixation device (16).

13. Method and system according to claims 1, 2 and 10 characterized by that each transducer (4) can hold supports or sockets to attach itself to an internal fixation device (33) that is in turn attached on the bone (1).

14. Method and system according to claims 1, 2 and 10 characterized by that each transducer (4) is attached to the bone (1) using a surgical wire (19) looped around the bone (1).

15. Method and system according to claims 1, 2 and 10 characterized by that each transducer (4) can be attached to the bone (1) using orthopaedic glue or orthopaedic cement.

16. Method and system according to claims 1, 2 and 10 characterized by that each transducer (4) can be attached onto or into the bone (1) using bone screw (12) or screws (12) or staples.

17. Method and system according to claims 1, 2 and 10 characterized by that each transducer (4) can be attached onto or into the bone (1) by means of external threading (14) of the housing (11) of the transducer (4).

18. Method and system according to claims 1 and 2 characterized by that each transducer (4) can be attached to and acoustically coupled to the extracorporeal portion of an external fixation pin (17) that is in turn supported by an external fixation device (16); thus the transducer-pin assembly (4 & 16) operates altogether as an ultrasound transducer.

19. Method and system according to claims 1, 2, 10, 11, 12, 13, 14, 15, 16, 17 and 18 characterized by that each transducer (4) incorporates piezoelectric element (10), housing (11), and holds orientating means, means of attachment to the bone (1), means of acoustical coupling with the bone (1) and wired or wireless means of connection to the electronic unit (7).

20. Method and system according to claims 1, 2, 10, 14, 15, 16 and 17 characterized by that each transducer (4) incorporates a magnetic body (35) fixated onto or in the bone (1) and an extracorporeal coil (36); transmission of signals to and from the magnetic body (35) is performed via the electromagnetic induction phenomenon or/and the magnetostriction phenomenon.

21. Method and system according to claims 1 and 2 characterized by that the electronic unit (7) can be either entirely implanted, or can be located extracorporeally, or some of its components can be implanted and some can be located extracorporeally.

22. Method and system according to claims 1 and 2 characterized by that the electronic unit (7) may locally analyze and store the acquired signals, and may also transmit via wired or wireless means the acquired signals and other contextual data to a computing unit (8); said computing unit (8) is placed either locally or remotely and is responsible for further signal analysis (26), storage (27) and the provision of a user interface (28).
